(19) United States
(12) Patent Application Publication
(10) Pub. No.: US 2006/0290991 A1
(43) Pub. Date: Dec. 28, 2006

(54) Device to effect micro-displacements of a display for digital images

(75) Inventor: Giuseppe Gregoris, Azzano Decimo (IT)

Correspondence Address: STEVENS DAVIS MILLER & MOSHER, LLP, 1615 L STREET, NW, SUITE 850, WASHINGTON, DC, 20036, US

(73) Assignee: G.P.E. Srl, Azzano Decimo (PN) (IT)

(21) Appl. No.: 10/558,244

(22) PCT Filed: May 27, 2004
(86) PCT No.: PCT/IB04/01742

§ 371 Date: Nov. 23, 2005

(30) Foreign Application Priority Data
May 28, 2003 (IT) UD2003A000114

(51) Int. Cl. G06K 15/00

(52) U.S. Cl. 358/3.07

(57) ABSTRACT

Device to effect micro-displacements of a support for digital images, in which the digital images are formed by a determinate matrix of pixels arranged in lines and columns perpendicular to each other. Each pixel has a determinate lateral size and between adjacent pixels a free space of determinate amplitude. The device has a fixed structure having an optical axis, support members keeping the support for digital images on a plane orthogonal to the optical axis, and actuator members arranged between the fixed structure and the support for digital images, to displace the support for digital images, along the plane and in the directions of the lines and columns, with respect to the optical axis. The actuator members are associated with electronic control elements and effect one or more unitary displacements, in the directions, each one equal to or less than the determinate amplitude of the free space between adjacent pixels.

### FIELD OF THE INVENTION

The present invention concerns a device to effect very small displacements, or micro-displacements, of a support for digital images, for example consisting of a liquid crystal display (LCD), able to be used in any known-type developing and printing apparatus whatsoever, commonly known as a “mini-lab”. The device comprises a series of actuators, advantageously of a piezoelectric type, associated with the external frame of said support in order to selectively effect movements, in the range of microns, with respect to a fixed structure, in directions perpendicular to each other. In this way it is possible to displace the support and hence the digital image with respect to the element to be printed on, by micrometric values such as to suitably cover also the spaces between pixels which make up the digital image and to have a very clear printed image, even when enlargements of considerable size are made.

### BACKGROUND OF THE INVENTION

An apparatus for developing and printing on light-sensitive paper photographic images impressed on a negative is known. By using a suitable adapter, this apparatus is also able to print, on the same light-sensitive paper, digital images produced by a camera or video recorder of a digital type, and/or processed by an electronic processor.

An adapter of the type cited above is described in the application for a patent of industrial invention PN2001A000084, which the Applicant filed on 29.11.2001. Such known adapter comprises a support for digital images consisting of a liquid crystal display (LCD), which is connected to an electronic calculator to receive in digital form every individual image to be printed. The support for digital images is located between a source of light and the light-sensitive paper. Moreover, dicroic, optical and anti-heat filters are located between the source of light and the support for digital images, while a shutter or diaphragm, which controls the exposure time, is located between the latter and the light-sensitive paper.

On the support for digital images each image is composed of a regular matrix consisting of 1,024×1,280 pixels, arranged on lines and columns perpendicular to each other. Each pixel is substantially square in shape, with sides of about 28μ. Between two adjacent pixels of the matrix, in both directions, there is a free space of 3.5μ, so that, in order to achieve a continuous effect between the pixels and to obtain a printed image which will have the same quality of images taken from photographic negatives, the known adapter provides both to use a pixel rounder device, and also to displace the support for digital images, in the directions of the lines and columns of the matrix of pixels, by a value equal to the size of half a pixel (14μ).

This known adapter, although it allows to obtain sufficiently clear images, still does not guarantee a print quality equal to that taken from photographic negatives.

One purpose of the present invention is to achieve a device able to effect very small movements, even in the order of a single micron, of a support for digital images with respect to the optical axis of illumination and the light-sensitive paper, in order to displace the matrix of pixels by values equal to a fraction of less than ½ of their lateral size, in both perpendicular directions of the matrix.

The Applicant has devised and perfected the present invention to overcome the shortcomings of the state of the art and to obtain other advantages.

### SUMMARY OF THE INVENTION

The present invention is set forth and characterized essentially in the main claim, while the dependent claims describe other innovative characteristics of the invention.

The device according to the present invention is able to effect micro-displacements of a support for digital images, in which these digital images are formed by a determinate matrix of pixels arranged on lines and columns perpendicular to each other, wherein each pixel has a determinate lateral size, and wherein between adjacent pixels there is a free space having a determinate amplitude.

The device according to the present invention comprises a fixed structure having an optical axis, support means able to keep the support for digital images on a plane orthogonal to the optical axis, and actuator means arranged between the fixed structure and the support for digital images in order to displace the support for digital images and the relative matrix of pixels, along said plane and in the directions of the lines and columns of the matrix, with respect to the fixed structure and hence with respect to the optical axis.

According to a characteristic of the present invention, the actuator means are associated with electronic control means, which are able to cause unitary displacements, in the perpendicular directions of the matrix of pixels, equal to or less than the aforesaid determinate amplitude of the free space between adjacent pixels.

Advantageously, the micro-displacements of the support for digital images are equal to ⅛ of the side of a pixel, therefore equivalent to the free space between the pixels which is precisely ⅛ of the aforesaid lateral size of the pixels.

The support for digital images advantageously comprises an external frame, rectangular in shape, which supports a liquid crystal display on which the matrix of pixels is formed. The actuator means comprise piezoelectric means located between the fixed structure and two first adjacent sides of the external frame.

First elastic means are located between the fixed structure and two second adjacent sides of the external frame in a position opposite the piezoelectric elements.

Friction reduction means are advantageously located between the piezoelectric elements and the support for digital images and possibly also between the aforesaid first elastic means and the support for digital images.

Second elastic means are provided to press the support for digital images towards the aforesaid support means, and further friction reduction means are advantageously located between the support for digital images and the support means.

### BRIEF DESCRIPTION OF THE DRAWINGS

These and other characteristics of the present invention will become apparent from the following description of a preferential form of embodiment, given as a non-restrictive example, with reference to the attached drawings wherein:

FIG. 1 is a general diagram of an apparatus for printing digital images on which a device according to the present invention is mounted;

FIG. 2 is a plane view of a device according to the present invention;

FIG. 3 is a section from III to III of FIG. 2;

FIG. 4 is a greatly enlarged detail of FIG. 2 in a first working position;

FIG. 5 is the detail of FIG. 4 in a second working position;

FIG. 6 is the detail of FIG. 4 in a third working position.

### DESCRIPTION OF A PREFERENTIAL FORM OF EMBODIMENT OF THE INVENTION

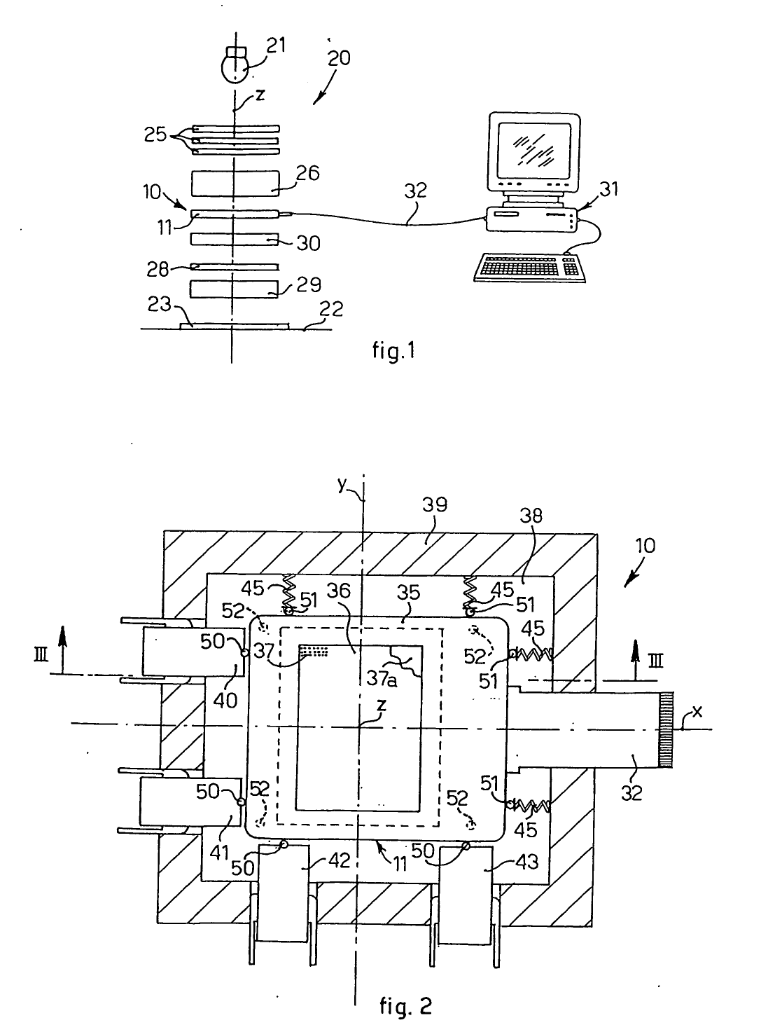

With reference to FIG. 1, a device 10 according to the present invention, able to effect micro-displacements of a support for digital images 11 of a known type, is shown applied to an apparatus 20 for developing and printing digital images, which comprises a source of light 21 able to project a bundle of light along an optical axis Z, a plane 22, orthogonal to the optical axis Z and on which light-sensitive paper 23 is arranged. Optical filters 25, for example dicroic and anti-heat, and a first optical unit 26, for example including mirrors, are located between the source of light 21 and the support for digital images 11. A shutter 28 and a second optical unit 29, for example including lenses, are located between the support for digital images 11 and the plane 22. Between the support for digital images 11 and the shutter 28 a pixel rounder device 30 is possibly arranged, which for example can be of the type described in the above cited application for a patent of industrial invention PN2001A000084.

The apparatus 20 also comprises an electronic processor 31 connected, by means of a data cable 32, with the support for digital images 11, in order to transmit to the latter, one at a time, the digital images to be printed on the paper 23.

The support for digital images 11 (FIG. 2) comprises an external frame 35, rectangular in shape, which supports a liquid crystal display (LCD) 36 on which, by means of the electronic processor 31, the digital image to be printed is formed, with a plurality of pixels 37 (for example 1,200×1,600), arranged on a matrix of lines and columns orthogonal to each other.

Light polarization filters 37a and 37b, of a known type, are arranged on the support for digital images 11, on opposite sides with respect to the display 36 and orthogonal to the optical axis Z.

The external frame 35 is supported by a supporting plane 38 (FIGS. 2 and 3), orthogonal to the optical axis Z, of a fixed structure 39 of the apparatus 20. A series of four piezoelectric elements 40, 41, 42 and 43 is located between the fixed structure 39 and two adjacent sides of the external frame 35 in order to effect micro-displacements of the latter and of the associated display 36 in the two directions X and Y, parallel to the lines, and respectively to the columns, of the matrix of pixels 37. Springs 45 are able to contrast the action of the piezoelectric elements 40, 41, 42 and 43. The latter are able to be selectively and individually activated by a control circuit, of a known type and not shown in the drawings, on the command of the electronic processor 31, in order to deform by determinate values, in the range of a micron, and cause corresponding micrometric displacements of the support for digital images 11 with respect to the supporting plane 38 of the fixed structure 39.

To reduce friction during the micro-displacements of the support for digital images 11, four balls 50 are located between the piezoelectric elements 40, 41, 42 and 43 and the external frame 35, and four balls 51 are located between the springs 45 and the external frame 35.

Moreover, four balls 52 are located between the external frame 35 and the supporting plane 38.

Above the external frame 35 (FIG. 3) a holed platelet 53 is arranged which, by means of springs 55, presses the frame 35 against the supporting plane 38 below. Four balls 56, opposite the balls 52, are located between the holed platelet 53 and the external frame 35.

In this way, the support for digital images 11 is guided in every direction and the balls 50, 51, 52 and 56 reduce friction to a minimum during its micro-displacements.

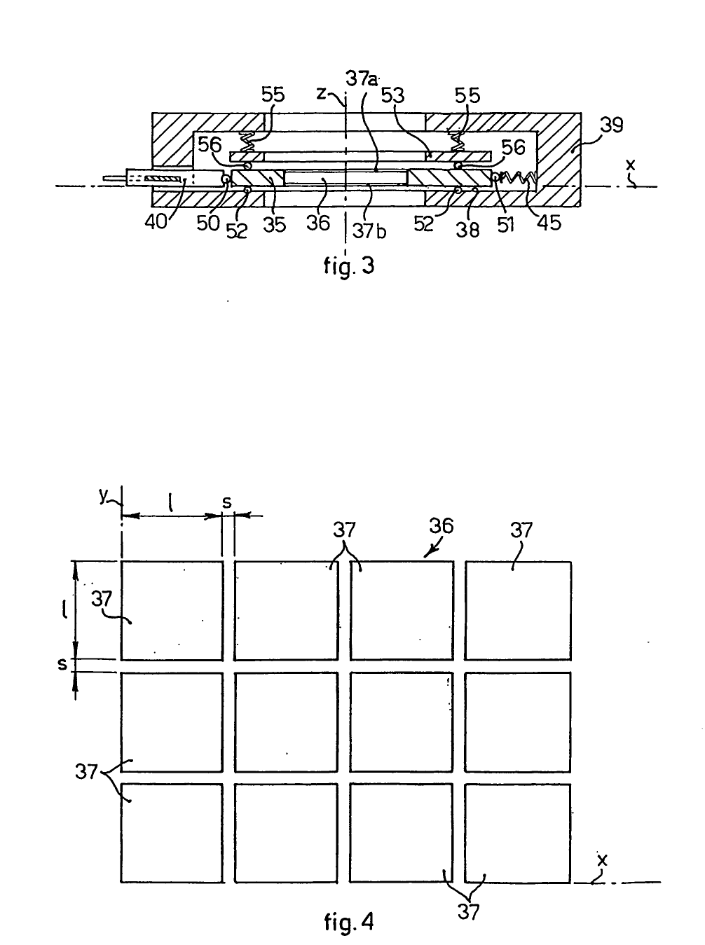

The pixels 37 (FIG. 4) of the display 36 have a square shape, with sides having a determinate size 1, equal for example to about 24μ, and are separated from the adjacent pixels by a free space having a size s, equal for example to about 3μ, that is, ⅛ of the size 1.

The device 10 as described heretofore functions as follows.

In the inactive position, with the piezoelectric elements 40, 41, 42 and 43 not activated, the support for digital images 11 is in the position shown in FIG. 2, with the pixels 37 in the first position shown in FIG. 4, for example with two of their sides aligned with the reference axes X and Y. In this position the apparatus 20 performs, in known manner, a first step of printing the digital image contained in the display 36.

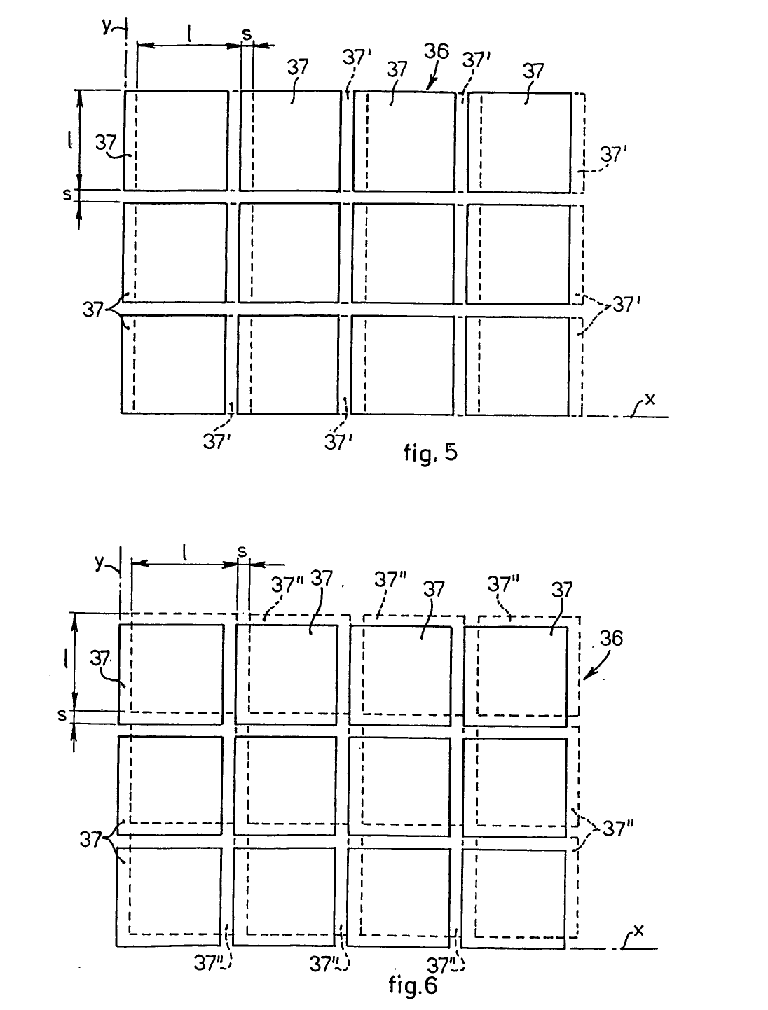

Before performing a second step of printing the same digital image contained in the display 36, the electronic processor 31 generates a signal that actuates the piezoelectric elements 40 and 41, so as to cause micro-displacements of the support for digital images 11 of a desired amplitude in direction X. For example, a displacement of the support 11 can be made to the left (FIG. 2), equal to s (FIG. 5), that is, equal to 3μ, taking the pixels 37 to the position 37′, displaced with respect to the axis Y but still aligned with the axis X, thus completely covering the vertical spaces between the columns of pixels 37, initially free.

The apparatus 20 then performs the second step of printing the same digital image contained in the display 36, with the pixels 37 displaced.

Before performing a third step of printing the same digital image contained in the display 36, the electronic processor 31 generates another signal which actuates the piezoelectric elements 42 and 43, so as to cause micro-displacements of the support for digital images 11 of a desired amplitude in direction Y. For example, a displacement of the support 11 can be made upwards (FIG. 2), equal to s (FIG. 6), that is, equal to 3μ, taking the pixels 37 to the position 37″, displaced with respect to both axis Y and also axis X, thus completely covering the horizontal spaces too, between the columns of pixels 37, initially free.

The apparatus 20 then performs the third step of printing the same digital image contained in the display 36, with the pixels 37 further displaced.

The process continues thus, selectively displacing several times, for example 8, in both directions X, Y, the support for digital images 11 orthogonally with respect to the optical axis Z, covering up to 64 different positions of the pixels 37 for the same image to be printed, thus obtaining a high print quality.

According to a variant, depending on the level of refinement and clarity to be obtained of the digital image to be printed, it is possible to effect micro-displacements of the support 11 equal to a fraction of s, for example 0.5 s, that is, 1.5μ. In this case 16 elementary displacements can be made in each direction X, Y, covering up to 256 different positions of the pixels 37 for the same image to be printed, thus obtaining an even higher print quality.

It is clear, however, that modifications and/or additions of parts may be made to the device 10 as described heretofore, without departing from the field and scope of the present invention. For example, the value of the unitary displacement can also be less than a micron, and the displacements in each direction X, Y can also be more than 16.

It is also clear that, although the present invention has been described with reference to a specific example, a skilled person in the art shall certainly be able to achieve many other equivalent forms of device to effect micro-displacements of a support for digital images, all of which shall come within the field and scope of the present invention.

1. Device to effect micro-displacements of a support for digital images, in which said digital images are formed by a determinate matrix of pixels arranged in lines and columns perpendicular to each other, wherein each of said pixels has a determinate lateral size, wherein between adjacent pixels there is a free space having a determinate amplitude, said device comprising: a fixed structure having an optical axis, support means able to keep said support for digital images on a plane orthogonal to said optical axis; and actuator means arranged between said fixed structure and said support for digital images, in order to displace said support for digital images along said plane and in the directions of said lines and said columns, with respect to said optical axis, wherein said actuator means are associated with electronic control means and is able to effect one or more unitary displacements, in said directions of said lines and said columns, each one equal to or less than said determinate amplitude of said free space between adjacent pixels.

2. Device as in claim 1, wherein said determinate lateral size is about 24μ and said determinate amplitude is about 3μ, wherein said unitary displacements are in the range of one micron.

3. Device as in claim 1, wherein said unitary displacements are equal to 3μ.

4. Device as in claim 3, wherein said unitary displacements are equal to eight for each of said directions.

5. Device as in claim 1, wherein said unitary displacements are equal to 1.5μ.

6. Device as in claim 5, wherein said unitary displacements are equal to sixteen for each of said directions.

7. Device as in claim 1, wherein said support for digital images comprises an external frame, rectangular in shape, which supports a liquid crystal display on which said matrix of pixels is formed, and said actuator means comprise piezoelectric elements located between said fixed structure and two adjacent sides of said external frame.

8. Device as in claim 7, wherein first elastic means are located between said fixed structure and two adjacent sides of said external frame in a position opposite to said piezoelectric elements.

9. Device as in claim 7, wherein electronic means is connected to said piezoelectric elements to cause the selective lengthening and shortening of said piezoelectric elements and consequent micro-displacements of said support for digital images with respect to said fixed structure.

10. Device as in claim 7, wherein first friction reduction means is advantageously located between said piezoelectric elements and said support for digital images.

11. Device as in claim 8, wherein second friction reduction means is located between said first elastic means and said support for digital images.

12. Device as in claim 7, wherein second elastic means is provided in order to press said support for digital images towards said support means.

13. Device as in claim 11, wherein third friction reduction means is advantageously located between said support for digital images and said support means.

14. Device as in claim 13, wherein fourth friction reduction means are advantageously located between said support for digital images and said second elastic means.

15. Device as in claim 12, wherein third friction reduction means is advantageously located between said support for digital images and said support means.
